(19) United States
(12) Patent Application Publication
(10) Pub. No.: US 2017/0313485 A1
(43) Pub. Date: Nov. 2, 2017

(54) THERMALLY ACTIVATED CUSHIONING MATERIAL AND METHOD OF MAKING THE SAME

(71) Applicant: Create Technologies, Inc., Carson City, NV (US)

(72) Inventor: Nicholas P. De Luca, Carmel-by-the=Sea, CA (US)

(73) Assignee: Create Technologies, Inc., Carson City, NV (US)

(21) Appl. No.: 15/393,834

(22) Filed: Dec. 29, 2016

Related U.S. Application Data
(60) Provisional application No. 62/330,840, filed on May 2, 2016.

(51) Int. Cl. B65D 65/42; B65D 81/02; B26D 3/08; B26D 3/10; B29D 7/01; B32B 3/02; B65D 65/46; B32B 23/04

(52) U.S. Cl. CPC B65D 65/42; B65D 65/466; B65D 65/44; B32B 23/04; B26D 3/10; B29D 7/01; B32B 3/02; B26D 3/085; B29D 2009/00; B32B 2307/30; B32B 2307/50; B32B 2307/718

(57) ABSTRACT

A cushioning material and a method to make the same is disclosed. The cushioning material includes: a cellulose base sheet; a co-layer binder disposed on the cellulose base sheet; and a plurality of discrete cuts disposed in the cellulose base sheet, wherein the cellulose base sheet is configured to be expanded and locked using heat activation and a solvent.

### CROSS-REFERENCE TO RELATED APPLICATIONS

The present application claims the benefit of U.S. Provisional Application No. 62/330,840 filed May 2, 2016, which is incorporated in its entirety herein by reference for all purposes.

### FIELD

The present teachings provide embodiments of a thermally activated cushioning material, and a method of making the thermally activated cushioning material. The cushioning material includes a base sheet of cellulose paper with a bonding agent adhered thereto. The base sheet is slit and then heated with the application of an activator including a solvent. The system can employ multiple devices, systems, operations, and the like to promote safe, efficient, and effective use of the devices and methods disclosed herein.

### BACKGROUND

Various package cushioning products made from paper exist intended for the protection of items to be shipped. Exemplary cushioning products include Ran Pack, Giami, and Pubble. These products use craft paper that is molded or formed at point of use in order to create a bulky material for the purpose of absorbing a shock load of an object wrapped within the material. However, these products require multiple sheets of paper to create a high density suitable for shock absorption.

Polyurethane foams, inflatable packaging, plastic foams, and thermoformed plastic are also used to protect items to be shipped but these have significant environmental impact and limited biodegradability.

Materials such as Corevue or fabricated cardboard are either difficult to recycle or stiff and use significant volume which increases shipping costs.

### SUMMARY

This Summary introduces a selection of concepts in a simplified form that is further described below in the Detailed Description. This Summary is not intended to identify key features or essential features of the claimed subject matter, nor is it intended to be used to limit the scope of the claimed subject matter.

The present teachings provide embodiments of a thermally activated cushioning material, and a method of making the thermally activated cushioning material. The cushioning material includes a base sheet of cellulose paper with a bonding agent adhered thereto. The base sheet is slit and then heated with the application of an activator including a solvent.

A cushioning material is disclosed. The cushioning material includes: a cellulose base sheet; a co-layer binder disposed on the cellulose base sheet; and a plurality of discrete cuts disposed in the cellulose base sheet, wherein the cellulose base sheet is configured to be expanded and locked using heat activation and a solvent.

A method for forming a package cushioning substrate is disclosed. The method includes: providing a cellulose base sheet co-layered with a bonding agent; cutting the cellulose base sheet into a discrete pattern of cuts; heating the cellulose base sheet, wherein the heating forms raised portions corresponding to the cuts in the cellulose base sheet.

Additional features will be set forth in the description that follows, and in part will be apparent from the description, or may be learned by practice of what is described.

### BRIEF DESCRIPTION OF THE FIGURES

In order to describe the manner in which the above-recited and other advantages and features can be obtained, a more particular description is provided below and will be rendered by reference to specific embodiments thereof that are illustrated in the appended drawings. Understanding that these drawings depict only typical embodiments and are not therefore to be considered to be limiting of its scope, implementations will be described and explained with additional specificity and detail with the accompanying drawings.

FIG. 1 is an isometric view of a base cellulose paper sheet incorporating a bonded adhesive layer and a cut pattern, according to various embodiments.

FIGS. 2A, 2B, 2C, 2D, 2E, 2F, 2G, 2H, 2I, 2J, and 2K are various exemplary flat cutting patterns to be placed on a base sheet.

FIG. 3 is an isometric view of an exemplary post heated substrate that has been cut per the flat cutting patterns of FIG. 2A and FIG. 2B.

FIG. 4 is an isometric view of an exemplary cushioning pad made using a post heated substrate that has been cut per the flat cutting pattern of FIG. 3.

FIG. 5 is an isometric view of an exemplary envelope formed using a post heated substrate that has been cut per the flat cutting pattern of FIG. 3.

FIG. 6 is an isometric view of an exemplary material using a post heated substrate that has been cut per the flat cutting pattern of FIG. 3 and integrated with a rigid or semi-rigid material, according to various embodiments.

FIG. 7 illustrates an exemplary machine to produce the cushioning material herein disclosed.

### DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure.

The terminology used herein is for describing particular embodiments only and is not intended to be limiting of the present disclosure. As used herein, the singular forms “a,” “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first,” “second,” and the like does not imply any particular order, but they are included to either identify individual elements or to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof. Although some features may be described with respect to individual exemplary embodiments, aspects need not be limited thereto such that features from one or more exemplary embodiments may be combinable with other features from one or more exemplary embodiments.

### Overview

The present teachings disclose a cushioning material including a base sheet of cellulose paper with a bonding agent adhered thereto. The base sheet is slit and then heated with the application of an activator including a solvent. In exemplary embodiments, the cushioning material is intended to protect items to be shipped.

The slitting of the base sheet performed in such a manner as to allow for the repetitive curling of the paper when heat is applied. The heat may be applied in a radiant, convective, or conductive form as well as through the use of microwaves.

The slitting may be performed on the base sheet. In exemplary embodiments, after the slitting has been performed, the slit base sheet may be rolled back up and used later or at a different location.

In exemplary embodiments, the solvent may be water. In some embodiments, the solvent may include a surfactant and activator to insure proper dispersion and activation of the bonding glue layer after the heat is applied. In exemplary embodiments, after application of the solvent the base sheet may curl. In exemplary embodiments, the curled product may be used for various packing material, such as, an envelopes, a wrap, a pads, a liner, or the like.

According to various embodiments, the present teachings disclose a cushioning material that is recyclable and biodegradable and can be expanded at the time of use.

According to various embodiments, the present teachings disclose a cushioning material that is easily adaptable to provide various cushioning characteristics.

According to various embodiments, the present teachings disclose a cushioning material that has a density of less than 0.0005 pounds per cubic inch (lbs/in³) when expanded and has a density of greater than 0.01 lbs/in³ prior to use.

According to various embodiments, the present teachings disclose a cushioning material shapeable or formable into wraps, envelopes, pads, liners or the like.

According to various embodiments, the present teachings disclose a cushioning material that expands and may be rolled in a high density roll prior to use.

The present teachings disclose the formation of a cushioning material with significant functional volume increase greater than 25-50 times. The material including a base sheet of cellulose paper may range in thickness from 0.003 to 0.010 inches with a bonding agent adhered to the cellulose paper. The material is slit using equipment such as a rotary die press with a repeating pattern of cuts. The cuts formed in patterns may be longitudinal, across the material, curved, or angular. The size and shape of the cuts may be predetermined to adjust for the cushioning characteristics required and the functional volume needed. After cutting, the base material may be heated to be formed for immediate use or be rolled up for later use. In exemplary embodiments, the base sheet may be adhered to other substrates for immediate or later expansion of the other substrates, when curling of the base sheet is activated.

The material may include a gummed sheet material, that is, sheet material having a coating of bonding agent or dry adhesive that can be moistened with water to develop an adhesive tackiness which permits the sheet to be attached to another surface. Adhesives of this nature are commonly called remoistenable adhesives, glue or gum and these terms are herein used to include any normally non-tacky adhesive that can be activated with water. In some embodiments, a binder is used to form the remoistenable adhesives. Exemplary binders may be selected from the group consisting of polyvinyl ester copolymers, polyvinyl chloride, butadiene styrene copolymers, and substantially water-insoluble polymers of acrylic esters.

Prior to heating, the application of an activator including a solvent is necessary to bind the formed paper. The preferable solvent being water but also potentially including a surfactant and activator to insure proper dispersion and activation of the bonding glue layer after the heat is applied. The slitting of the base sheet performed in such a manner to allow for the repetitive curling of the paper when heat is applied and the binder insuring the “fixing” of the curl. The heat may be applied in a radiant, convective, or conductive form as well as through the use of microwaves. The curled product further allowing for the formation of envelopes, wraps, pads, and liners.

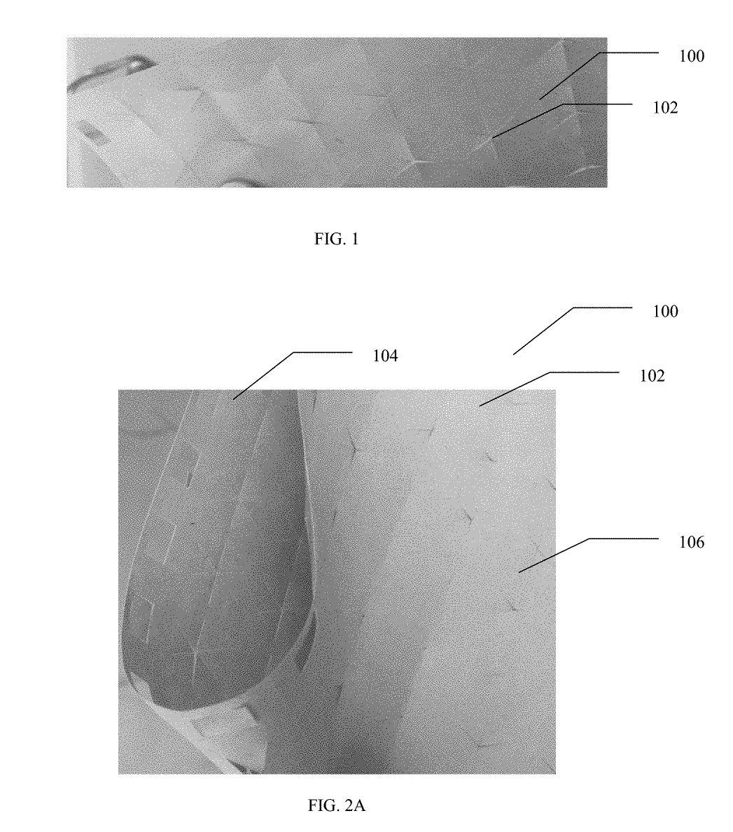

FIG. 1 is an isometric view of a base cellulose paper sheet incorporating a bonded adhesive layer and a cut pattern, according to various embodiments.

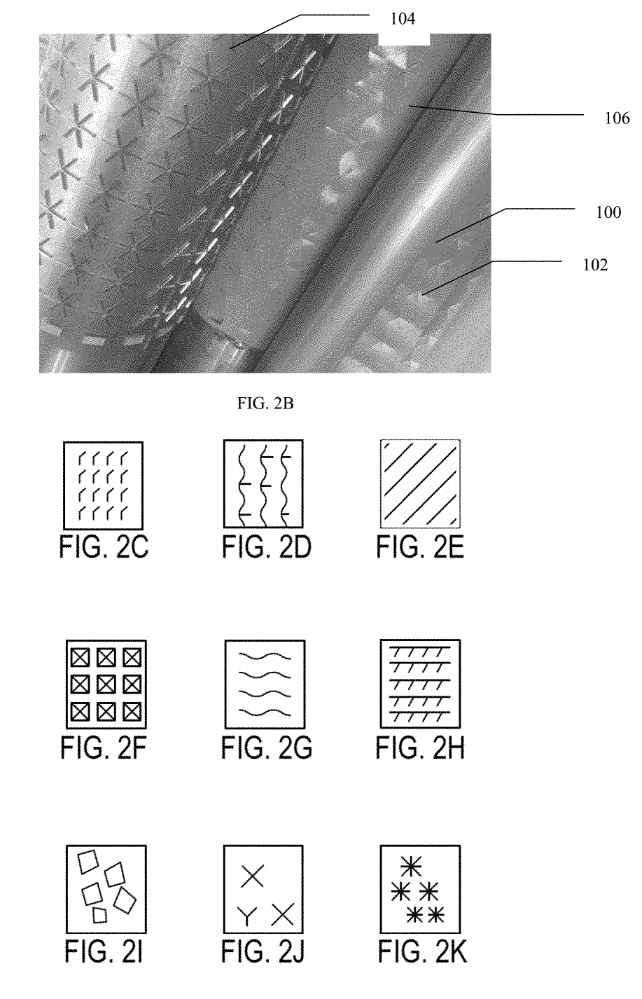

FIGS. 2A, 2B, 2C, 2D, 2E, 2F, 2G, 2H, 2I, 2J, and 2K are various exemplary flat cutting patterns to be placed on a base sheet.

In the above FIGS. a base cellulose paper sheet 100 has slits 102 formed therein. The base paper sheet 100 may have a co-layer binder 104 applied on a first face of the base sheet 100. A second face 106 opposing the first face of the base sheet 100 may be free of an adhesive or co-layer binder.

The slits 102 may be formed with an embossed roller 110 (see FIG. 2B). In exemplary embodiments, the base sheet 100 may be slit by star shaped slits 102. See, for example, FIG. 2B roller 110. Other shapes for the slits are depicted in FIGS. 2C-2K. Exemplary slit shapes include chevron shaped slits (FIG. 2C), curved slits optionally accompanied with orthogonal straight slits (FIG. 2D), parallel slits disposed on a bias of the paper sheet (FIG. 2E), X-shaped slits within square boxes (FIG. 2F), curved slits (FIG. 2G), parallel slits with diagonal slits disposed within the parallel slits (FIG. 2H), odd-shaped parallelograms (FIG. 2I), X-shaped slits (FIG. 2J), and asterisk shaped slits (FIG. 2K).

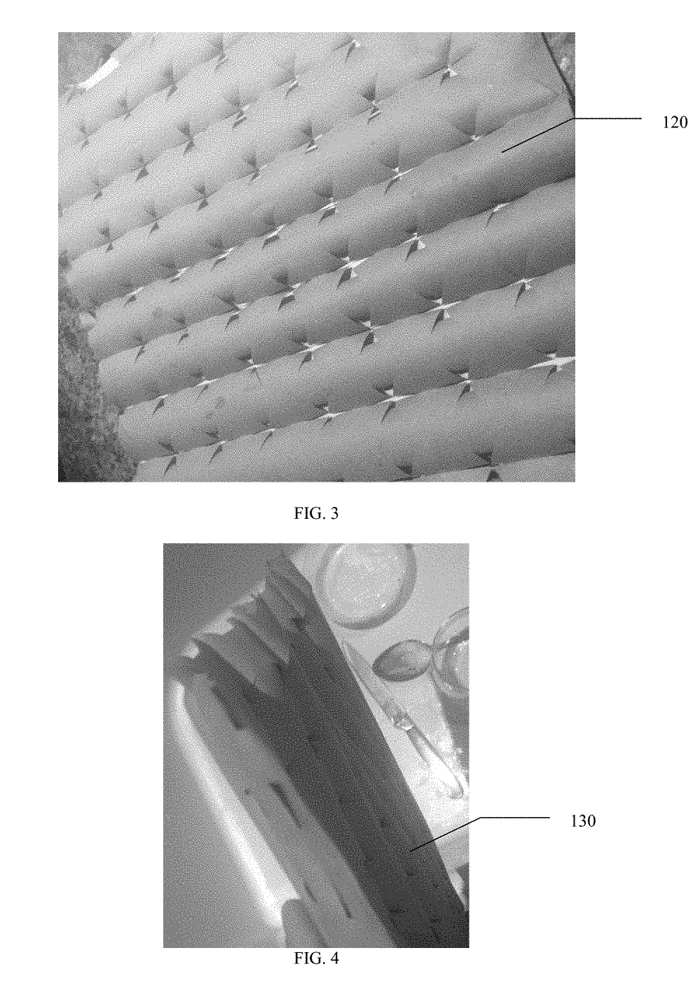

FIG. 3 is an isometric view of an exemplary post heated substrate that has been cut per the flat cutting patterns of FIG. 2A and FIG. 2B.

The base sheet 100 of FIG. 2B can have a solvent applied thereto and then heat-treated to form a curled sheet 120 as shown in FIG. 3.

FIG. 4 is an isometric view of an exemplary cushioning pad made using a post heated substrate that has been cut per the flat cutting pattern of FIG. 3.

The base sheet 100 of FIG. 2B can have a solvent applied thereto and then heat-treated to form a curled sheet 130 as shown in FIG. 3.

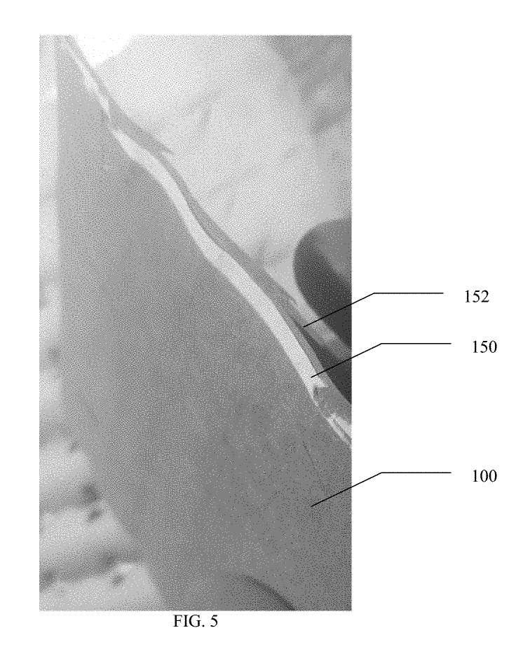

FIG. 5 is an isometric view of an exemplary envelope formed using a post heated substrate that has been cut per the flat cutting pattern of FIG. 3.

The base sheet 100 of FIG. 2B can have a solvent applied thereto and then heat-treated to form a curled sheet 130 as shown in FIG. 3.

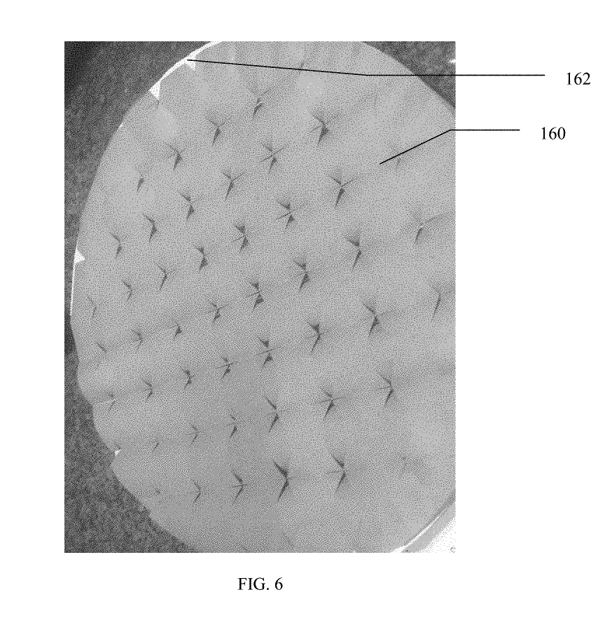

FIG. 6 is an isometric view of an exemplary material using a post heated substrate 160 that has been cut per the flat cutting pattern of FIG. 3 and integrated with a rigid or semi-rigid material 162, according to various embodiments.

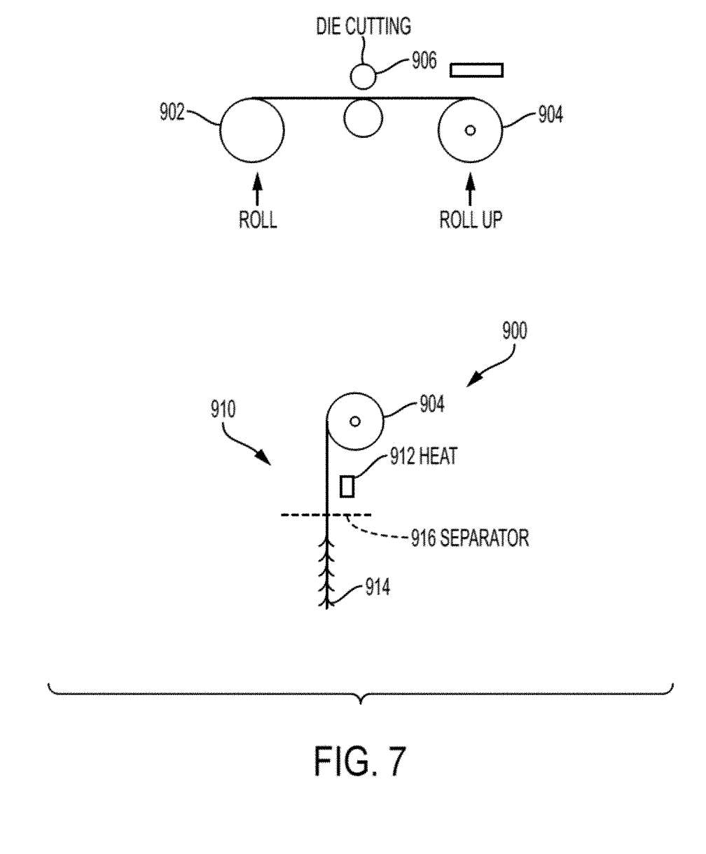

FIG. 7 illustrates an exemplary system to produce the cushioning material herein disclosed.

An exemplary system 900 may be provided with a roll 902 of base sheet material. In exemplary embodiments, one surface of the base sheet material may have a co-layer binder disposed thereupon. The base sheet from the roll 902 can be passed through a die-cutter roller 906 to form slits therein. The base sheet with the slits can be taken up with into a roll-up 904. At or near a point of use, the roll-up roller 904 can have a solvent applied thereto by a solvent applicator 910. The solvent applicator 910 can be sprayer, a brush, or the like. After having the solvent applied to the base sheet with the slits, the base sheet can be heat cured by an oven 912 and passed through a separator 916 to have the base sheet form a curled sheet 914.

### CONCLUSION

Although the subject matter has been describe method of claim 7d in language specific to structural features and/or methodological acts, it is to be understood that the subject matter in the appended claims is not necessarily limited to the specific features or acts described above. Rather, the specific features and acts described above are disclosed as example forms for implementing the claims. Other configurations of the described embodiments are part of the scope of this disclosure. Further, implementations consistent with the subject matter of this disclosure may have more or fewer acts than as described, or may implement acts in a different order than as shown. Accordingly, the appended claims and their legal equivalents should only define the invention, rather than any specific examples given.

I claim:

1. A cushioning material comprising:
a cellulose base sheet;
a co-layer binder disposed on the cellulose base sheet; and
a plurality of discrete cuts disposed in the cellulose base sheet,
wherein the cellulose base sheet is configured to be expanded and locked using heat activation and a solvent.

2. The cushioning material of claim 1, wherein the heat activation is provided using heat generated as radiant, convective, conduction or a combination thereof heat.

3. The cushioning material of claim 1, wherein the heat activation is provided using microwave heating.

4. The cushioning material of claim 1, wherein the solvent comprises water.

5. The cushioning material of claim 1, wherein the solvent comprises a suspension comprising a sealing agent selected from a wax, silicone, oil, or a plastic polymers.

6. The cushioning material of claim 1, wherein the solvent comprises water and a suspension comprising a sealing agent selected from a wax, silicone, oil, or a plastic polymers.

7. The cushioning material of claim 1, wherein the binder is selected from the group consisting of polyvinyl ester copolymers, polyvinyl chloride, butadiene styrene copolymers, and substantially water-insoluble polymers of acrylic esters.

8. The cushioning material of claim 1, wherein the cellulose base sheet is formed to create an envelope.

9. A method for forming a package cushioning substrate comprising:
providing a cellulose base sheet co-layered with a bonding agent;
cutting the cellulose base sheet into a discrete pattern of cuts;
heating the cellulose base sheet, wherein the heating forms raised portions corresponding to the cuts in the cellulose base sheet.

10. The method of claim 9, wherein the heat activation is provided using heat generated as radiant, convective, conduction or a combination thereof heat.

11. The method of claim 9, wherein the heat activation is provided using microwave heating.

12. The method of claim 9, wherein the solvent comprises water.

13. The method of claim 9, wherein the solvent comprises a suspension comprising a sealing agent selected from a wax, silicone, oil, or a plastic polymers.

14. The method of claim 9, wherein the solvent comprises water and a suspension comprising a sealing agent selected from a wax, silicone, oil, or a plastic polymers.

15. The method of claim 9, wherein the binder is selected from the group consisting of polyvinyl ester copolymers, polyvinyl chloride, butadiene styrene copolymers, and substantially water-insoluble polymers of acrylic esters.

16. The method of claim 9, wherein the cellulose base sheet is formed to create an envelope.
